(19) United States
(12) Patent Application Publication
(10) Pub. No.: US 2025/0329855 A1
(43) Pub. Date: Oct. 23, 2025

(54) BATTERY ARRANGEMENT WITH A COVER ELEMENT MADE OF PLASTIC AND HAVING RIB-LIKE SUPPORTING PORTIONS, AND MOTOR VEHICLE WITH SUCH A BATTERY ARRANGEMENT

(71) Applicant: AUDI AG, Ingolstadt (DE)

(72) Inventor: Julius RAUSCH, HEILBRONN (DE)

(73) Assignee: AUDI AG, Ingolstadt (DE)

(21) Appl. No.: 19/185,414

(22) Filed: Apr. 22, 2025

(30) Foreign Application Priority Data
Apr. 23, 2024 (DE) 102024111266.2

(51) Int. Cl. H01M 50/278; H01M 10/613; H01M 10/625; H01M 10/6556; H01M 50/249; H01M 50/289

(52) U.S. Cl. CPC H01M 50/278; H01M 10/613; H01M 10/625; H01M 10/6556; H01M 50/249; H01M 50/289

(57) ABSTRACT

A battery arrangement for an at least partially electrically powered motor vehicle, including a battery box; a plurality of battery modules arranged next to one another in the battery box; a cooling plate arranged on a respective battery module with at least one coolant channel; a cover element made of a plastic material, which is arranged on the battery box so that the battery modules and the cooling plates are covered. The cover element has rib-like support portions facing the battery modules, which support the cover element on the cooling plates.

### FIELD

The invention relates to a battery arrangement for an at least partially electrically powered motor vehicle, comprising a battery box; a plurality of battery modules arranged next to one another in the battery box; a cooling plate arranged on a respective battery module with at least one coolant channel; a cover element made of a plastic material, which is arranged on the battery box so that the battery modules and the cooling plates are covered.

### BACKGROUND

A battery arrangement with a battery tray and cover element is known, for example, from DE 11 2020000 386 T5. EP 2 650 946 B1 discloses a battery housing with a cover element made of sheet metal. Furthermore, DE 10 2019 206 646 A1 shows a battery arrangement with a lower cover made of plastic that serves as underride guard.

In the case of cover elements made of sheet metal, there are hardly any options, or only very complex ones in terms of the resulting costs, to create complex three-dimensional geometries in order to enable optimal support or optimal force transmission in the event of a crash event.

### SUMMARY

The object of the invention is to provide a battery arrangement with a cover element so that improved support or force transmission can be achieved.

The invention thus proposes a battery arrangement for an at least partially electrically powered motor vehicle, comprising a battery box; a plurality of battery modules arranged next to one another in the battery box; a cooling plate arranged on a respective battery module with at least one coolant channel; a cover element made of a plastic material, which is arranged on the battery box so that the battery modules and the cooling plates are covered. It is provided that the cover element has rib-like support portions facing the battery modules, which support the cover element on the cooling plates.

The rib-like support portions can, on the one hand, improve the rigidity of the cover element itself and, on the other hand, the cover element can be supported at several points on the battery modules or cooling plates

In the battery arrangement, the support portions can be arranged on the cover element in such a way that, in the assembled state, they rest on regions of the cooling plate which are formed between coolant channels.

In other words, the support portions can be provided depending on a course of coolant lines of an underlying cooling plate, in such a manner. In this case, the supporting portions can extend, in particular in a vertical direction of the motor vehicle, in a valley formed in the cooling plate between two raised coolant channels.

In the battery arrangement, the support portions may have a shape that at least partially corresponds to a shape of the upper side of the cooling plate. In particular, the support portions can be substantially the same length or approximately longer in the height direction than a recess of the cooling plate formed between two coolant channels. Furthermore, it is also conceivable that at least one of the support portions is formed in a form-fitting manner with a recess formed between two coolant channels.

In the battery arrangement, the cover element may have a plurality of support elements which are in contact with a longitudinal member which is arranged in the battery box between two adjacent battery modules extending in the longitudinal direction of the motor vehicle. This can improve the transmission of forces to load-bearing structures such as the longitudinal member.

The support elements can be designed to form a form-fitting fit with a space formed between a battery module and a longitudinal member. As a result, the battery module can be supported on the longitudinal member, in particular in a width direction of the motor vehicle, in particular in the event of a lateral displacement of the battery module in the event of a crash event.

Furthermore, the support elements can rest on an upper side of the battery modules or the cooling plate in the region of an upper longitudinal edge of the battery modules. This allows the battery module to be better secured, particularly in a vertical direction.

In the battery arrangement, the cover element can be manufactured using a pressing process or an injection molding process. It can be made of a fiber-reinforced thermoplastic or fiber-reinforced thermosetting plastic. By using such plastic materials and corresponding manufacturing processes, more complex three-dimensional structures, such as the support portions and carrying portions described above, can be formed integrally on the cover element in a simple and cost-effective manner.

Furthermore, a motor vehicle with at least partially electric drive and with a battery arrangement as described above is proposed.

### BRIEF DESCRIPTION OF THE FIGURES

Further advantages and details of the invention will become apparent from the following description of embodiments with reference to the figures. In particular:

FIG. 1 shows a simplified and schematic sectional view of a battery arrangement;

FIG. 2 shows a simplified and schematic partial view of a motor vehicle with battery arrangement;

FIG. 3 shows a simplified and schematic plan view of an opened battery arrangement, a cover element and the closed battery arrangement.

### DETAILED DESCRIPTION

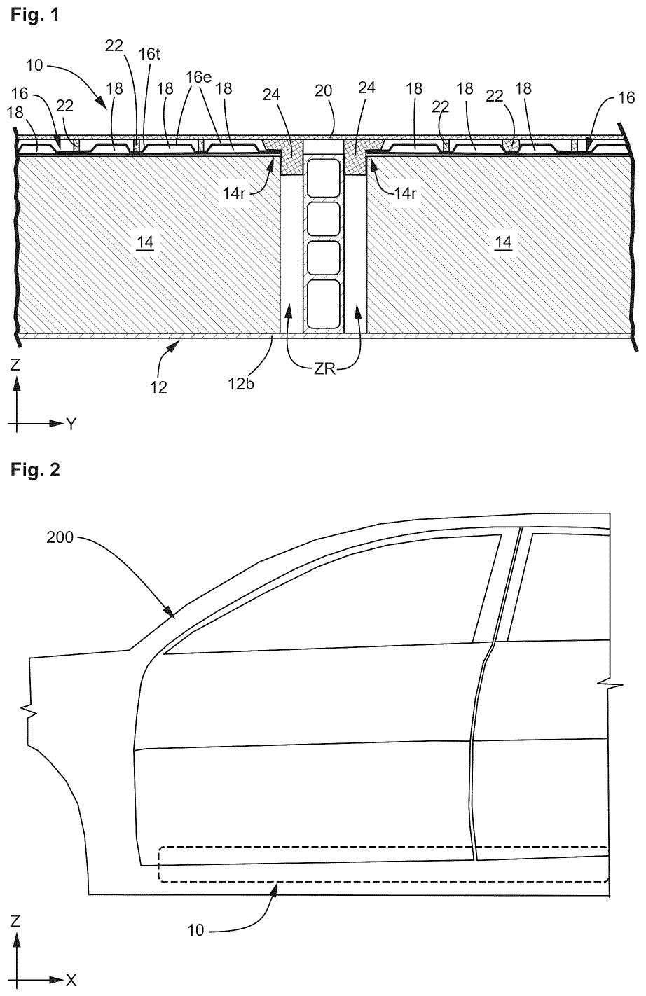

FIG. 1 shows a battery arrangement 10 in a simplified and schematic sectional view. The sectional view is based on a sectional plane determined by a width direction Y and a height direction Z of a motor vehicle.

The battery arrangement 10 is provided for a partially electrically or fully electrically powered motor vehicle 200, shown in simplified form in FIG. 2. FIG. 2 thus shows a motor vehicle 200 with a battery arrangement 10, which is shown only as a dashed rectangle and is described in more detail below.

Referring again to FIG. 1, it can be seen that the battery arrangement 10 has a battery box 12. Of the battery box 12, only a box bottom 12b is shown in FIG. 1. The battery box 12 can also be referred to as a battery tray.

The battery arrangement 10 comprises a plurality of battery modules 14 arranged next to one another in the battery box 12.

Typically, the individual battery modules 14 comprise s plurality of battery cells, which are not shown separately here.

A cooling plate 16 is arranged on each battery module 14 and has at least one coolant channel 18. In the example shown, the respective cooling plates 16 have a plurality of coolant channels arranged next to one another in the width direction Y, through which coolant flows, in particular in parallel or serially.

The cooling plate 16 is designed such that the coolant channels 18 are designed upwards (in the Z direction) as raised regions 16e. Between the raised regions 16e, respective depressions 16t are formed.

The battery arrangement 10 further comprises a cover element 20 made of a plastic, which is arranged on the battery box 12 so that the battery modules 14 and the cooling plates 16 are covered. The cover element 20 can in particular be connected to the battery box 12, for example screwed and/or materially connected (glued or welded).

The cover element 20 has rib-like support portions 22 facing the battery modules 14, which support the cover element 20 on the cooling plates 16. The rib-like support portions 22 are shown here in a simplified rectangular form, but can also have other shapes.

The support portions 22 are arranged on the cover element 20 in such a way that, in the assembled state, they rest on regions of the cooling plate 16 which are formed between coolant channels 18. In particular, the support portions 22 are arranged such that they rest in the recesses 16t on the cooling plates 16.

The support portions 22 have a shape that at least partially corresponds to a shape of the upper side 16s of the cooling plate 16. In particular, the support portions 22 have a length or height in the Z direction that is substantially equal to or greater than the depth of the recesses 16t.

With regard to the second support portion 22 from the right, it is pointed out that the support portions 22 can also be formed in a form-fitting manner with the recesses 16t.

In the battery arrangement 10, the cover element 20 can have, in addition to the rib-like support portions 22, a plurality of support elements 24 which are in contact with a longitudinal member 26. The longitudinal member 26 is arranged in the battery box 12 between two adjacent battery modules 14 in the longitudinal direction X (FIG. 2) of the motor vehicle 200.

The support elements 24 are in particular designed to form a form-fitting fit with an intermediate space ZR formed between a battery module 14 and the longitudinal member 26.

Furthermore, the support elements 26 can rest on an upper side of the battery modules 14 or the cooling plate 16 in the region of an upper longitudinal edge 14r of the battery modules 14.

In the example shown, the support elements 26 have a kind of L-shape. However, other shapes are also conceivable.

In the described battery arrangement 10, the cover element 10, in particular with its support portions 22 and the support elements 26, is manufactured in a pressing process or an injection molding process. It can be made of a fiber-reinforced thermoplastic or fiber-reinforced thermosetting plastic material.

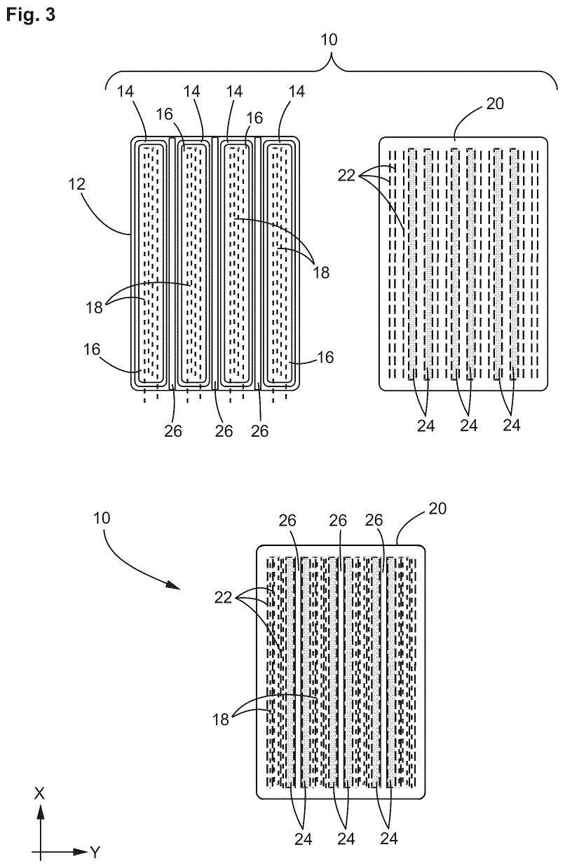

FIG. 3 shows a simplified and schematic plan view of a battery box 12 in the top left, in which multiple, here for example four, battery modules 14 are arranged next to one another. On the battery modules 14, respective cooling plates 16 are visible with coolant channels 18 shown in dotted lines. Longitudinal supports 26 of the battery box 12 are shown between the battery modules 14.

In FIG. 3, a cover element 20 is shown in a simplified and schematic manner at the top right. The cover element 20 comprises the rib-like support portions 22 and the support elements 24. The support portions 22 and the support elements 24 are shown in dashed lines as they are arranged on an underside of the cover element 20, wherein in FIG. 3 the view is taken onto an upper side of the cover element 20. For better recognition, the support elements 26 are marked with a dotted pattern.

In FIG. 3, the battery arrangement 10 with battery box 12 and cover element 20 arranged thereon is shown in the bottom center. From this top view it can be seen that the support portions 22 shown in dashed lines are arranged between the coolant channels 18 shown in dotted lines. Furthermore, the dotted patterned support elements 24 are arranged along the longitudinal members 26.

By means of the described battery arrangement 10, more complex three-dimensional structures, such as the above-described support portions 22 and support portions 24, can be formed integrally on the cover element 20 in a simple and cost-effective manner by using plastic materials for the cover element 20 and corresponding manufacturing processes. As a result, the cover element 20 can be adapted in its shape, in particular in its shape on its underside or on its side facing the battery modules 14 or cooling plates 16, to specific configurations of battery modules 14 and/or cooling plates 16, which also leads to a simplified adaptation of cover elements 20 for different battery arrangements of different motor vehicles.

1. A battery arrangement for an at least partially electrically powered motor vehicle, comprising:
a battery box;
a plurality of battery modules arranged next to one another in the battery box;
a cooling plate arranged on a respective battery module with at least one coolant channel;
a cover element made of a plastic material, which is arranged on the battery box so that the battery modules and the cooling plates are covered,
wherein the cover element has rib-like support portions facing the battery modules, which support the cover element on the cooling plates.

2. The battery arrangement according to claim 1, wherein the support portions are arranged on the cover element in such a way that, in the assembled state, they rest on regions of the cooling plate which are formed between coolant channels.

3. The battery arrangement according to claim 2, wherein the support portions have a shape which at least partially corresponds to a shape of the upper side of the cooling plate.

4. The battery arrangement according to claim 1, wherein the cover element has a plurality of support elements which are in contact with a longitudinal member which is arranged in the battery box between two adjacent battery modules extending in the longitudinal direction of the motor vehicle.

5. The battery arrangement according to claim 4, wherein the support elements are designed to form a positive fit with an intermediate space formed between a battery module and a longitudinal member.

6. The battery arrangement according to claim 4, wherein the support elements rest on an upper side of the battery modules or the cooling plate in the region of an upper longitudinal edge of the battery modules.

7. The battery arrangement according to claim 1, wherein the cover element is produced in a pressing process or an injection molding process and that it is made of a fiber-reinforced thermoplastic or thermosetting plastic.

8. A motor vehicle having an at least partially electric drive and a battery arrangement according to claim 1.

9. The battery arrangement according to claim 2, wherein the cover element has a plurality of support elements which are in contact with a longitudinal member which is arranged in the battery box between two adjacent battery modules extending in the longitudinal direction of the motor vehicle.

10. The battery arrangement according to claim 3, wherein the cover element has a plurality of support elements which are in contact with a longitudinal member which is arranged in the battery box between two adjacent battery modules extending in the longitudinal direction of the motor vehicle.

11. The battery arrangement according to claim 5, wherein the support elements rest on an upper side of the battery modules or the cooling plate in the region of an upper longitudinal edge of the battery modules.

12. The battery arrangement according to claim 2, wherein the cover element is produced in a pressing process or an injection molding process and that it is made of a fiber-reinforced thermoplastic or thermosetting plastic.

13. The battery arrangement according to claim 3, wherein the cover element is produced in a pressing process or an injection molding process and that it is made of a fiber-reinforced thermoplastic or thermosetting plastic.

14. The battery arrangement according to claim 4, wherein the cover element is produced in a pressing process or an injection molding process and that it is made of a fiber-reinforced thermoplastic or thermosetting plastic.

15. The battery arrangement according to claim 5, wherein the cover element is produced in a pressing process or an injection molding process and that it is made of a fiber-reinforced thermoplastic or thermosetting plastic.

16. The battery arrangement according to claim 6, wherein the cover element is produced in a pressing process or an injection molding process and that it is made of a fiber-reinforced thermoplastic or thermosetting plastic.
